(19) United States
(12) Patent Application Publication
(10) Pub. No.: US 2005/0223745 A1
(43) Pub. Date: Oct. 13, 2005

(54) Method and equipment for bending and tempering of glass

(75) Inventor: Risto Nikander, Tampere (FI)

Correspondence Address: STITES & HARBISON PLLC, 1199 NORTH FAIRFAX STREET, SUITE 900, ALEXANDRIA, VA, 22314, US

(73) Assignee: FERACITAS OY, Tampere (FI)

(21) Appl. No.: 10/509,939

(22) PCT Filed: Apr. 2, 2003
(86) PCT No.: PCT/FI03/00252

§ 371 Date: Oct. 1, 2004

(30) Foreign Application Priority Data
Apr. 3, 2002 (FI) 20020632

(51) Int. Cl. C03B 23/025

(52) U.S. Cl. 65/104; 65/273; 65/287; 65/114

(57) ABSTRACT

Method and equipment for glass (G) bending and tempering, in which the glass is first heated in oven in to bending temperature and it is moved over known transfer means, like rotating rollers (R) and after the glass has reached bending temperature it is transferred in to bending section, in which the glass (G) is allowed to bend on special bending ring (BR) and the said transferring the glass onto the bending ring (BR) takes place by moving the glass horizontally by transfer force exerted onto it. When the glass arrives into the location of the bending ring (BR), the supporting the glass from below is changed into air flow directed onto the bottom surface of the glass and the glass elevation plane is maintained by forming planar glass lifting stop means (CP) above the glass and at the location of the bending ring (BR) and blowing air through the lifting stop means so that air film is formed in between the glass and glass lifting stopping means, preventing glass lifting and eliminating touching of the glass with lifting stop means and when the glass has arrived over the mould (BR), the blowing from below the glass is stopped and the glass is allowed to bend.

The invention relates to a method and an equipment for bending and tempering of glass, in which method the glass is first heated up to the bending temperature in oven while it is moved in the oven by transfer means like on rotating rollers and after the bending temperature has been reached, it is transferred into bending section, in which the glass is allowed to bend located onto a special mould, before cooling for tempering.

Earlier this kind of method is known of US patent publication 3,338,695, in which the glass is conveyed by rollers from heating section into bending section over the bending ring all the time by means of rollers. The method includes larger diameter rollers, which can receive flat glass in the bending section. The rollers are deeply grooved in the locations, in which the ring mould is “embedded” below the top level of the rollers. When the glass has been transferred over the larger rollers just above the ring mould, the roller frame of larger rollers is descended so that hot glass is located on the ring mould and it bends. The disadvantage of this method is, that while the glass arrives onto larger rollers, these rollers are so few, that glass bends somewhat down due to the large roller distance. This causes optical distortions, which do not disappear in actual bending on the ring mould. Different ring moulds require variations into large rollers, at least on locations of the grooves, which reason leads into expensive rollers sets for different kinds of ring moulds.

Also from US publication 4,282,026 is known is vacuum lifter by which the flat glass is lifted up from rollers, transferred over the ring mould and dropped onto the ring mould. The disadvantage of this is, that the glass is in contact with vacuum lifter and therefore the vacuum lifter, which would damage the glass, has to be covered by ceramic, fibre glass or other hot resistant material. Another disadvantage is detaching of the glass from vacuum lifter while the glass is laid down onto the ring mould. If the vacuum is stopped slowly, the glass may hover sideways just before it is loses contact with the lifter, as the friction disappears from between the lifter and the glass. The glass will not locate accurately on the ring mould. If the vacuum is eliminated quickly and changed into blow, the hot glass drops quickly on the mould. This may easily cause excess sag in the central areas of the glass, as there is no support in the middle of the glass. This kind of lifter is not suitable for coated, selective glass, as the easily damaged coating has to be on the top side of the glass due to rollers underside.

Therefore, the problems has been, how to transfer the flat glass from rollers onto ring mould so, that the surface of the glass is not damaged and it will not be distorted or and no optical faults will be induced on the glass during the transfer. The intent of the invention is to create a new reliable method, by which the glass can be transferred onto a ring mould. The characteristic to the invention for achieving this goal is, that the transfer of the glass over the ring mould takes place by moving the glass horizontally by force exerted onto the glass and supporting the glass from underneath by blowing air from below and maintaining the elevation plane of glass during the transfer by forming above the glass planar the glass lifting stop means and blowing film air through the planar lifting stop means creating air film in between the glass and the stopping means so that the glass is prevented from lifting up and from touching the lifting stop means and after the glass has been moved over the ring mould, the blowing from underneath is stopped and the glass is allowed to bend on the mould.

Characteristic to the equipment according to this invention is, that for transferring the glass over the ring mould, there is air blowing from under the glass and in order to maintain the elevation plane of the glass during the transfer, there is a vertical planar glass lifting stopping means, which includes equipment, like blowing arrangement, perforated plate or planar arrangement of air nozzles in order to create air film between the glass and the glass lifting stop means.

Other advantageous ways to conduct the novel invention are described in the dependent claims.

The advantage of the novel invention is, that it provides reliable means to transfer hot glass from rollers of roller heart oven onto ring mould firstly without special tools. The rollers and ring mould can be ordinary tools and they do not require changes. The glass can be transferred accurately on the correct position over the ring mould. The top side of the glass is not touched during the transfer. The glass is not subjected to unwanted distortions, optical faults nor surface scratches. The glass transfer can take place in hot oven, in glass bending temperature and with short change over time. The method is well suited for medium and high capacity serial production levels.

In the following the novel invention is described more in detail with reference to the drawings, in which

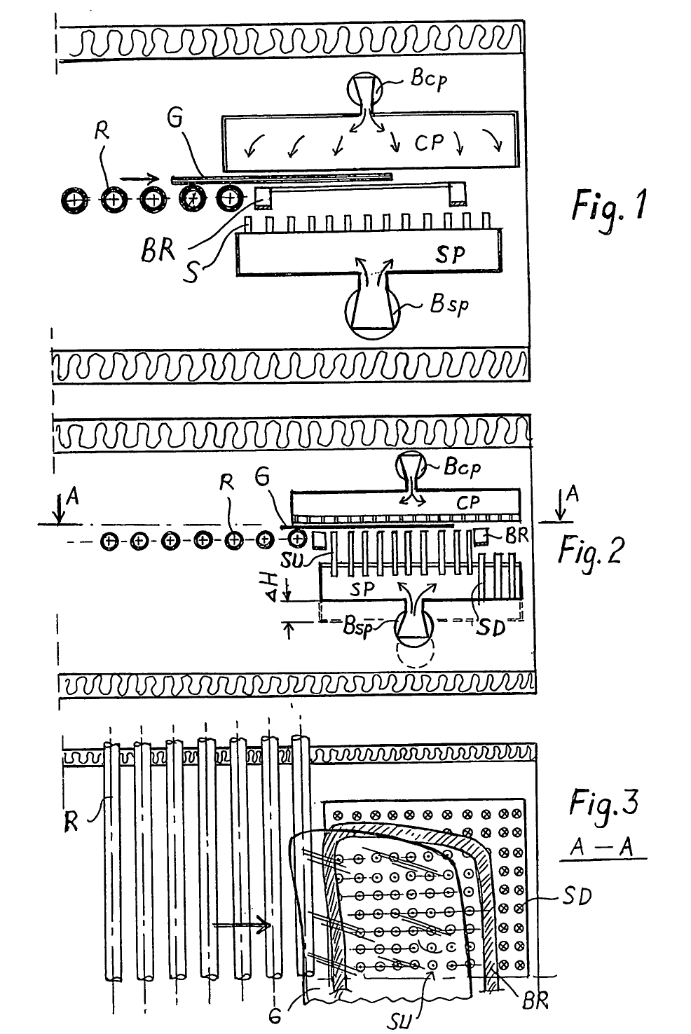

FIG. 1 shows the principle of the oven, in which there is the transfer system according to the novel invention.

FIG. 2 shows phase in the oven, in which the transfer of the glass over to the ring mould is taking place.

FIG. 3 shows top view of FIG. 2, section A-A.

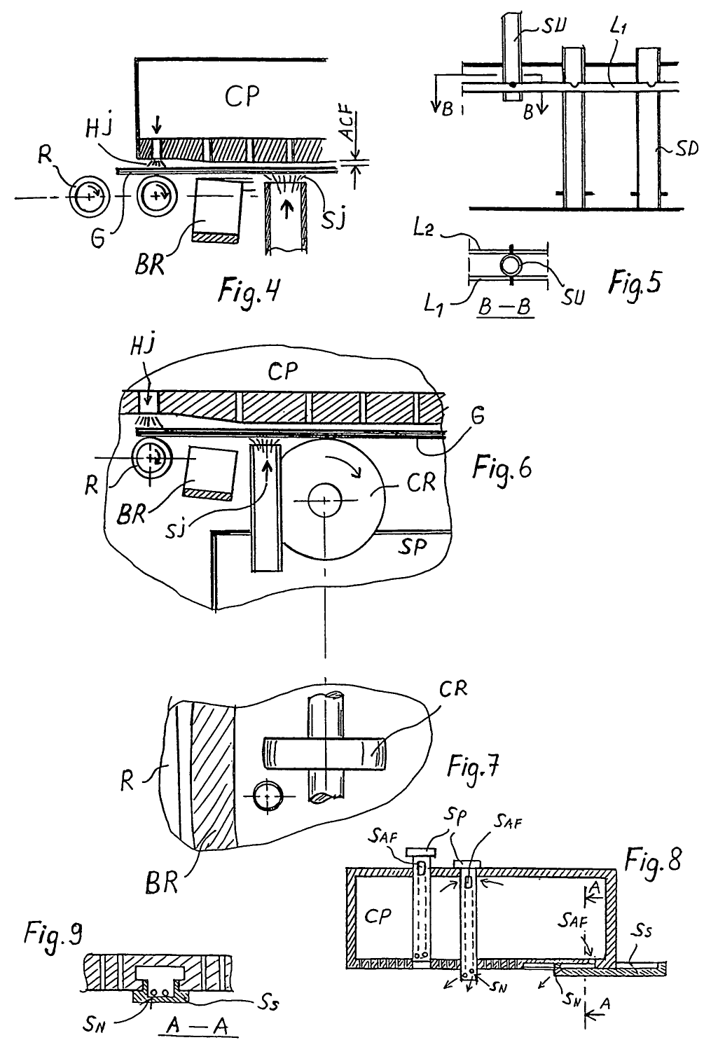

FIG. 4 shows detail of holding jet over the last roller.

FIG. 5 shows detail of lifting means for selective lifting of nozzles.

FIG. 6 shows a way of novel invention performance, in which there is a roller supporting and transporting the glass.

FIG. 7 shows detail of detail of FIG. 6 from above.

FIG. 8 shows various equipment for stopping and guiding the glass.

FIG. 9 shows cross section of glass stopper capable for horizontal adjustment.

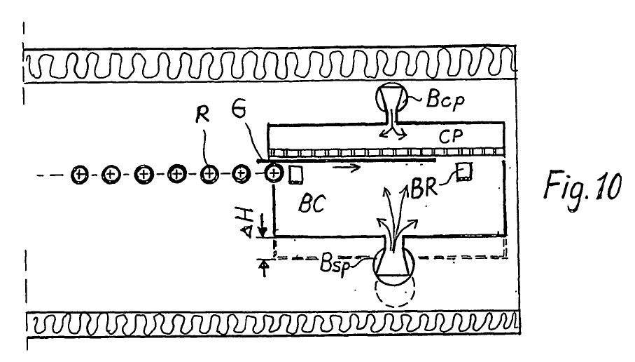

FIG. 10 shows a way of novel invention performance, in which the glass is supported from below by air pressure inside of the blowing chamber instead of nozzles.

FIG. 1 is a schematic cross section of furnace, in which there is a conveyor path made of rollers, R. At the end of conveyor path there is a ring mould, BR, immediately after the last roller. The glass G is moving over the ring mould. As a moving member of the novel invention there is a blowing box SP furnished with nozzles, S and blower unit, Bsp. Above the ring mould there is a glass G lifting stop means, which includes air blowing box CP, the bottom side of which is a perforated plate or nozzles and blower unit Bcp. Both blowers blow hot air of the oven, as the subject section is a bending section.

FIG. 2 shows the glass transfer phase, in which the rollers R and especially the last roller still transfers the glass over the ring mould. When the glass G has sled into the area, where there are no more rollers, the glass support is achieved by air blowing. Out of movable nozzles, nozzles SU have been lifted above the chamber SP so that their top level is the same and just a little lower than the top level of the rollers. Also the highest point of the ring mould has to be below the roller level so that the glass will not hit the mould during the transfer. The unnecessary nozzles, SD are at low position and air is not blown through them. The blower Bsp has been adjusted so, that air flow through nozzles SU clearly can support the glass G.

Just about 2-5 mm above the glass there is glass lifting stop means. The blower Bcp causes quite small but sufficient air flow through the perforated plate towards the glass top surface so that it creates air film between the glass and perforated plate. Thus glass will never touch the perforated plate or tips of the nozzles. Rotation of rollers and especially the last roller keeps the glass moving so that it moves over the ring mould. The convey of glass during the last stage can be ensured by inclining counter surface CP down in direction of the glass travel or directing air jets in the direction of glass travel.

The ring mould is furnished by stoppers, which stop the glass onto the correct location.

When the glass has been stopped over the ring mould, the bottom side blowing is stopped so that the glass descends on to the ring mould BR. As the lower side unit SP, together with nozzles, can be lowered down by distance ΔH, so also by this movement the glass descends down onto the ring mould. At least the nozzles SU must be lowered down so that the glass can bend. Alternatively the whole unit SP is lowered or both, nozzles SU and unit Sp are lowered. After the bending the glass is processed further by press bending or it is just tempered.

FIG. 3 describes situation of FIG. 2 seen from above, just half of the oven is pictured. There are nozzles in larger area than required by the ring mould BR. Nozzles SU are open and blow air onto the glass. Nozzles SD are at lower position and are not supposed to blow air when used in connection of this ring mould.

A special detail is shown in FIG. 4, in which a powerful air jet is blown over the last roller R so that it presses the glass against the roller so that the last rollers more securely move the glass as long as the edge of the glass passes the roller. The distance ACF between the glass G and perforated plate of glass lifting stop means CP, describes the thickness of air film between the said parts.

FIG. 5 shows another arrangement for lifting and descending the nozzles, in which nozzle rows include bars L1 and L2. The nozzles can be turned into the position so that bars fitted onto the nozzles hit slots and the nozzles lift up together with bars or they have been turned into position, in which they do not lift up with the bars.

Alternatively a separate template, located under the lower blowing box Sp can be used to lift up the nozzles. The lift able template lifts up via lifting bars only those nozzles, which are in the same position with the template. Template can be used to move the nozzles in up-or down position. The nozzles can also be numbered and equipped with actuators for the lifting purposes.

FIGS. 6 and 7 show arrangement, in which inside the ring mould BR there is one or more support rollers CR, which support the glass and which have been equipped with rotation arrangements. The roller CR can be used to secure the travel of the glass up to the stoppers. The roller CR descends together with blower unit for the duration of bending.

FIG. 8 shows another glass stopping arrangement, in which a pipe Sp can be pushed from top side chamber CP so, that its lower end comes down at least to the level, where the glass travels. This kind of stopper can be side guide or end stopper, against which glass hits. At the lower end of the stopper pipe Sp there are nozzles SN, from which air jets exit towards the glass and try to stop complete contact Thus, when it functions as a side guide, it acts as completely frictionless guide and does not exert onto the glass force, which would hinder the glass movement. The air can enter into the pipe Sp through holes SAF.

FIG. 8 shows a horizontally movable guide or stopper SS, which also includes air jets SN from its guiding or stopping surfaces towards the edge of the glass. FIG. 9 shows cross section of sliding arrangement, in which a groove, for example dovetail, fits the parts one to another thus allowing adjustment of the location of stopper or guide. The adjustment can be performed from outside of the oven by actuators, which include scale showing its position. Air jets soften the stopping of the glass or enable frictionless guiding of the glass.

The arrangement of FIG. 10 achieves supporting blowing effect onto the glass G without nozzle arrangement by use of blowing box BC under the glass. The air flow from blower Bsp is directed onto underside of the glass and supporting effect on the glass is created immediately after the glass leaves the rollers R and enters into the area of the mould BR. This arrangement is advantageous, because the nozzles are not needed at all. Only the ring mould BR has to be changed when the glass type changes.

1. A method for bending and tempering of a glass (G), in which method the glass is first heated in oven into bending temperature and it is moved over known transfer means, like rotating rollers (R) and after the glass has reached bending temperature it is transferred into a bending section, in which the glass (G) is allowed to bend on special bending ring (BR), and the said transferring the glass onto the bending ring (BR) takes place by moving the glass horizontally by transfer force exerted onto it, characterized in that when the glass arrives into the location of the bending ring (BR), the supporting of the glass (G) by rollers from below is changed into air flow supporting by directing air onto the bottom surface of the glass and the horizontal height level of the glass is maintained by forming planar glass elevation stop means (CP) above the glass at the location of the bending ring (BR) and further by blowing air through the elevation stop means so that air film is formed in between the glass and glass elevation stop means, said blowing preventing glass elevation and eliminating touching of the glass with elevation stop means.

2. A method according to the claim 1 characterized in that the air blow onto the bottom surface of the glass is achieved through various nozzles (SU) arranged on the same level.

3. A method according to the claim 1 characterized in that the nozzles (SU) can be lowered down one by one or the whole nozzle chamber (SP) can be lowered to down position.

4. A method according to the claim 1 is known in that the supporting effect on to the glass (G) is achieved by forming a chamber (BC) under the glass and the chamber has open face towards the glass and directing air flow towards the glass from below.

5. A method according to the claim 1 characterized in that the glass elevation stop means is perforated plate or nozzle plate and air is blown through the holes and the dynamic effect of this blowing is remarkably lower than the blow directed on the bottom surface of the glass.

6. A method according to the claim 1 characterized in that the glass is moved over the mould (BP) by transfer force achieved by rollers (R).

7. A method according to the claim 1 characterized in that the glass is transferred over the mould (BR) by wheel (CR) located in the area of the mould and under the glass.

8. A method according to the claim 1 characterized in that for transferring the glass by roller (R), air jets are directed on the on the top surface of the glass so that they press the glass down substantially on the location of the roller (R) in order to improve the transfer effect.

9. A method according to the claim 1 characterized in that the entrance and stopping of the glass over the mould is assisted by mechanical stoppers (Sp), (Ss), and out of their contact surfaces air is blown out against the edge of the glass.

10. An equipment for glass (G) bending and bending and tempering oven includes glass heating section for glass heating up to bending temperature and glass transfer means, like rotating rollers (R) over which the glass in bending temperature is transferred into bending section, in which bending mould (BR) is located and on which the glass is allowed to bend before tempering, characterized in that for transferring the glass onto the bending mould (BR), the equipment includes under the glass and at the location of the bending ring (BR), an air blowing system by which system the rollers (R), which are supporting the glass, are substituted and for maintaining the horizontal heigt level of the glass during the transfer, said equipment includes planar glass elevation stop means (CP) located above the glass at the location of the bending ring (BR), which stop means further includes an air blowing arrangement (Bcp) and perforated plate or set of nozzles arranged in planar form so that air film is formed between the glass (G) and glass elevation stop means.
